(19) United States
(12) Patent Application Publication
(10) Pub. No.: US 2003/0037293 A1
(43) Pub. Date: Feb. 20, 2003

(54) Providing access to diagnostic information to an interested party, such as a computer remote support agent

(76) Inventor: Eric Owhadi, Sassenage (FR)

Correspondence Address: LADAS & PARRY, Suite 2100, 5670 Wilshire Boulevard, Los Angeles, CA, 90036-5679, US

(21) Appl. No.: 10/165,863

(22) Filed: Jun. 7, 2002

(30) Foreign Application Priority Data
Jun. 8, 2001 (EP) 01410070.5

(51) Int. Cl. G06F 11/30

(52) U.S. Cl. 714/46

(57) ABSTRACT

A method of providing access to computer diagnostic information to an interested party comprising:

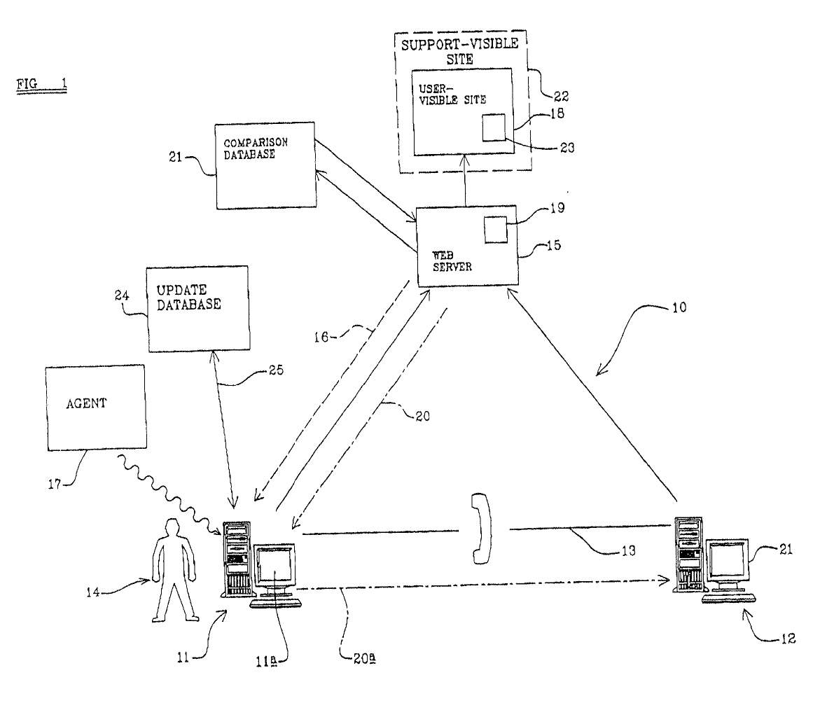

a) obtaining the information,

b) passing the information to a holding location unknown to the interested party,

c) receiving, using the computer, a location identifier, and

d) transmitting the location identifier to the interested party to enable the party to access the information at said holding location.

### SUMMARY OF AND BACKGROUND TO THE INVENTION

This invention relates to a method of providing access to computer diagnostic and configuration information to an interested party, to an arrangement and apparatus for providing remote support to a computer user, and to apparatus for obtaining remote support for a computer user.

In particular, although by no means exclusively, the invention relates, in broad terms, to remote user support facilities whereby a computer user, experiencing difficulties with his/her computer may contact a support agent with a view to obtaining guidance and technical instruction to assist the user to overcome the problem concerned.

Although a variety of such remote support systems are known, each has several drawbacks. The predominant shortcoming is caused by the fact that during a “trouble-shooting” call, the support agent will often ask the user to send the support agent files such as diagnostic results, log files, screen shots and system configuration information. Although this is technically feasible, sending the required files can be a complex process, and thus unattractive to less experienced computer users. Moreover, as transmission of the files using e-mail can introduce delays (in that e-mail transmissions are based on a “pull” approach), sending the files in this way does not constitute an ideal solution.

In accordance with a first aspect of the present invention, there is provided a method of providing access to computer diagnostic information to an interested party comprising:

a) obtaining the information,

b) passing the information to a holding location unknown to the interested party,

c) receiving, using the computer, a location identifier, and

d) transmitting the location identifier to the interested party to enable the party to access the information at said holding location.

The holding location preferably is an Internet site, visible to a user of the computer.

The location identifier may be transmitted to the interested party in a form differing from that in which it is received by the computer.

The computer configuration information may be passed to the holding location using a first data channel, the location identifier being transmitted using a second, different, data channel.

The location information transmitted by the computer may be imperceptible by the user, or may be such that it does not allow the user to understand the information directly.

Preferably, the transmission is encoded, the interested party thus performing a decoding operation in order to access the information.

Conveniently, the transmission comprises a sound.

The transmission may be such that it does not allow a human to understand the information directly from the transmission.

The decoding operation may thus comprise a transduction step.

The Internet site preferably is created dynamically using the configuration information.

Computer-specific information may also be transmitted to the interested party, the computer-specific information being used by the interested party to obtain comparison information for the purpose of comparing the computer's configuration to other, possible configurations.

The computer-specific information may comprise the computer's serial number and/or model number.

The comparison information may be extracted from a remote database, the comparison information being used dynamically to create a support-visible Internet site, differing from the user-visible site.

The user-visible site and the support-visible site may both be created using a servlet resident on a mutually accessible Web server.

The support-visible site way be generated and accessed substantially automatically upon receipt by the interested party of the location identifier and/or computer-specific information.

The location identifier and computer-specific information may be transmitted to the interested party using a telephonic connection.

The location identifier preferably comprises part or all of the URL of the user-visible Internet site.

The configuration information may comprise diagnostic result files, the Web server passing the files to the user-visible Internet site as an HTML file.

Preferably, the configuration information is obtained by an agent received from an Internet source. The agent may be a locally executed trusted component such as an applet or ActiveX control.

Preferably, a connection is established with an update database, such that updated or replacement software components may be downloaded to the computer.

The connection may be established using the or an additional servlet.

In accordance with a second aspect of the present invention, there is provided an arrangement for providing remote support to a computer user, comprising:

a) a configuration information gathering element, operable to gather configuration information relating to the computer,

b) a configuration information dispatch element, operable to dispatch the configuration information to a holding location,

c) a location identifier receiving element, operable to receive a location identifier which identifies the holding location,

d) a location identifier transmission element, operable to transmit the location identifier to a remote support agent, and

e) a support agent connection element, operable to establish a connection to the holding location, whereby the support agent may access the configuration information.

In accordance with a third aspect of the present invention there is provided, in a support agent environment, apparatus for providing remote support to a computer user, comprising

a) a location identifier receiving element, operable to receive, from the computer, a location identifier which identifies a holding location at which is held configuration information relating to the computer, and

b) a support agent connection element, operable to establish a connection to the holding location, whereby the support agent may access the configuration information.

The location identifier receiving element may comprise a decoder, to decode the location identifier, which is such that it does not allow a human directly to understand the information provided thereby.

In accordance with a fourth aspect of the present invention, there is provided, in a client environment, apparatus for obtaining remote support for a computer user, comprising:

a) a configuration information gathering element, operable to gather configuration information relating to the computer,

b) a configuration information dispatch element, operable to dispatch the configuration information to a holding location,

c) a location identifier receiving element, operable to receive a location identifier which identifies the holding location,

d) a location identifier transmission element, operable to transmit the location identifier to a remote support agent, whereby the support agent may access the configuration information to provide remote support to the user.

### BRIEF DESCRIPTION OF THE DRAWING

An embodiment of the invention will now be described, but strictly by way of example only, by reference to the accompanying drawing, which illustrates, in schematic form, the various components and processes used when the invention, in its various aspects, is put into practice.

Referring to the FIGURE, this shows a remote support arrangement generally indicated at 10 by which a user 14 of a PC 11 may obtain remote support from a support agent shown generally at 12. The support agent, as will be appreciated, may be located some way from the PC 11, and a telephonic connection 13 is thus established between them, using a conventional land-line telephonic communication link. In order for the support agent 12 to be able effectively to assist the user, the support agent requires detailed information concerning the configuration and set-up of the PC 11. In order to extract this information from the computer, the user (illustrated generally at 14) has two options. First of all, the user could execute pre-installed diagnostic routines on the PC 11 which generate, in conventional manner, a number of files containing diagnostic test results, log files and system configuration information. To do this, however, the user will either need substantial prior experience or detailed guidance on a step-by-step basis front the support agent 12. This approach, therefore, is less than ideal.

An automated configuration information gathering process is thus preferred. To enable this to be achieved, the user 14 is prompted by the support agent 12 to access a specific (e.g. Hewlett-Packard) support Website, using a browser application (not shown) featured within the PC 11. Accessing the Website, via a Web server 15, causes an applet 16 to be executed in the PC 11's browser environment, with the applet 16 generating a “pop-up” prompt box on the PC's display screen 11a. If, in response to the prompt box (not shown for reasons of clarity), the user 14 indicates that he/she will trust the support site, the applet 16 effects a download of a configuration information gathering agent 17 from an appropriate (perhaps separate) Website. The information gathering agent then runs, in generally conventional form, within the PC 11, and harvests hardware/software configuration data from within the PC.

Whichever approach is chosen by the user 14, the end result is that information relating to the configuration of the hardware and software associated with the PC 11 is obtained, with it then being necessary to convey this information to the support agent 12. It will be understood, of course, that at this stage in the process, a telephonic connection 13 is all that exists between the user 14 and the support agent 12. Although it would be possible for the user 14 to obtain hard copies of the configuration information thus gathered, and to send the information (e.g. by fax) to the support agent 12, this is likely to give rise to a number of operational difficulties, not least in that it would be difficult for the support agent 12 to “tally” the incoming fax with the existing telephonic connection, bearing in mind that customer support is invariably provided by multi-operator call centres.

In view of this, the invention allows the configuration information to be passed to a holding location which in this case is a user-visible Website 18. In brief, the applet 16 prompts the user 14 to upload the configuration information to the Web server 15 using HTTP, with the Web server 15 then “translating” the received configuration information to HTML. The HTML file is then uploaded, using a servlet 19, embedded within the Web server 15, to the user-visible site 18. It is again worth noting, that at this stage of the process, the telephonic connection 13 is stir all that remains between the user 14 and the support agent 12: thus, at this point, the support agent 12 has no way of accessing the configuration information now provided on the user-visible Website 18. To provide the Support agent 12 with access to the configuration information, the servlet generates a location identifier 20 which identifies the user-visible site 18. In its simplest form, this may constitute the URL of the site 18, with this information conveniently being displayed to the user 14 via the screen 11a of the PC 11. At this point, the user 14 may simply dictate the URL of the site to the support agent 12 over the telephone, although, as will be appreciated, the length (i.e. number of characters) and complexity of the URL may not only make this inconvenient, but may also give rise to a serious possibility of errors being made at both ends of the telephonic connection 13. The invention thus provides for automatic transmission of the location identifier to the support agent 12, by converting the identifier received from the Web server 15 into a transmission 20a which comprises a number of sounds which are representative of the location identifier. The sounds, which are chosen so as to be readily transmissible using a standard telephonic connection, may vary, in their pitch, frequency and spacing to identify the location of the site 18. Whilst, at one extreme, the sounds could be understandable by the (human) support agent 12, it is envisaged that a more effective communication could be established by encoding the sonic transmission in a form that is not understandable directly by the human support agent 12. The support agent's PC 21 is thus provided with a transducer (not shown) which is able to convert the incoming sonic code to computer-readable information which is then used, in conjunction with the PC 21's Web browser, to access the site 18. This enables the support agent 12 to see the configuration information provided on that site. It will be appreciated that not all of the URL may need to be transmitted: the “home” page is already known to the support agent, and it may therefore suffice to transmit the latter part of the URL, to enable the connection to be made.

From the user's perspective, the support agent 12 is provided with the configuration information purely by virtue of the telephonic connection, although, in truth, the data transfer is effected using HTTP connectivity.

Whilst, in some cases, access to the “user-generated” site 18 may in itself enable the support agent 12 to diagnose and rectify a fault on the user's PC 11, it is often the case that additional information will be required by the support agent.

To this end, the servlet 19 adds to the site 18 by incorporating comparison data received from a comparison database 21. The comparison data includes information relating to current versions of hardware and software releases, for example, with this information being displayed in conjunction with, or alongside, the user-specific configuration information uploaded to the site 18. The effect of this, from the support agent's viewpoint, is that an “embellished” support-visible site 22 is generated, with the embellished site having been created dynamically by the servlet 19. The support-visible site 22 thus enables the support agent 12 to analyse the hardware/software components provided on the user's PC 11 in the light of currently available alternatives. As will be appreciated, this provides the support agent 12 with a number of “pointers” to possible remedial actions: if, for example, the user 14 is experiencing difficulties with a printer or scanner, the support visible site 22 may show to the support agent 12 that the user's printer/scanner drivers are out of date, and suggest that they be updated with contemporary (i.e. current) versions.

If, having performed a diagnosis in this way, the support agent 12 decides that a software update (or patch) is required, the support agent 12 is able to effect this, again using the servlet 19. In brief, dispatch of appropriate commands from the support agent's PC 21 to the servlet 19 causes the servlet to launch a trusted Java applet 23 from within the user-visible site 18 (to which, at that point, the user's PC 11 is connected). The applet 23, being trusted, is allowed to operate outside the sandbox of the user's PC 11, and thus effects a connection between the user's PC 11 and a remote update database 24.

Alternatively, the servlet 19 may simply use the applet 16, which is already running in the user's browser, to effect the download. This may be preferable, as it obviates the requirement of a further “trust” request.

The connection 25 may be a Web connection—i.e. HTTP-based—or may be a dial-up database connection of generally conventional type. Once the connection 25 is established, an appropriate software update is downloaded to the PC 11 from the update database 24, and installed on the PC 11 in generally conventional manner.

The result of this, as will be appreciated, is that the user 14 is able to obtain a comprehensive diagnosis by the support agent 12 simply by uploading diagnostic files (for example) to a mutually assessable Website, and by providing the support agent with an encoded identifier which allows the support agent 12 to access the uploaded data. From the user's perspective, the process is deceptively simple: all that the user need do is to upload the diagnostic files to a Website, and to transmit sounds generated by the PC 11 to the support agent 12 using a conventional telephonic connection 13. This can be achieved simply by placing the user's telephone handset next to the speaker/buzzer of the PC 11, as the sounds are generated within a frequency band that can readily be transmitted using conventional telephone networks. Moreover, the comparison and update steps require little or no input on the part of the user, as the support visible site 22 is generated by the servlet 19, with the servlet 19 also effecting the update process, should that be required.

To provide the user with security against unauthorised access to the user-visible site 18, it is envisaged by the applicants that access to this site may be password-protected, such that the support agent 12 is required to enter a user ID and/or password before access to the site 18 will be allowed

Finally, it will be understood by those well versed in the art that the term “computer” is not to be interpreted too narrowly, in that the invention could well be applied to other electronic apparatus having a computing facility. Thus, it is envisaged by the applicants that the present invention could perhaps be used to diagnose faults on a range of domestic electronic goods, such as video recorders, televisions, DVD players and game-playing consoles.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of providing access to computer diagnostic information to an interested party comprising:
a) obtaining the information,
b) passing the information to a holding location unknown to the interested party,
c) receiving, using the computer, a location identifier, and
d) transmitting the location identifier to the interested party to enable the party to access the information at said holding location.

2. A method according to claim 1 wherein the holding location is an Internet site visible to the interested party.

3. A method according to claim 1 wherein the location identifier is transmitted to the interested party in a form differing from that in which it is received by the computer.

4. A method according to claim 1 wherein the computer diagnostic information is passed to the holding location using a first data channel, the location identifier being transmitted using a second, different, data channel.

5. A method according to claim 4 wherein the location information transmitted by the computer is imperceptible by the user, or is such that it does not allow the user to understand the information directly.

6. A method according to claim 4 wherein the transmission is encoded, the interested party performing a decoding operation in order to access the information.

7. A method according to claim 4 wherein the transmission comprises a sound.

8. A method according to claim 7 wherein the transmission is such that it does not allow a human to understand the information directly from the transmission.

9. A method according to claim 8 wherein the decoding operation comprises a transduction step.

10. A method according to any one of claim 2 wherein the Internet site is created dynamically using the diagnostic information.

11. A method according to claim 1 wherein the diagnostic information comprises configuration information.

12. A method according to claim 1 wherein computer-specific information is also transmitted to the interested party, the computer-specific information being used by the interested party to obtain comparison information for the purpose of comparing the computer's configuration to other, possible configurations.

13. A method according to claim 12 wherein the computer-specific information comprises the computer's serial number and/or model number.

14. A method according to claim 13 wherein the comparison information is extracted from a remote database, the comparison information being used dynamically to create an Internet site.

15. A method according to claim 13 wherein more than one internet site is created using a servlet resident on a Web server.

16. A method according to claim 15 wherein at least one site is generated and accessed automatically upon receipt by the interested party of the location identifier and/or computer-specific information.

17. A method according to claim 2 wherein the location identifier is at least a part of the URL of the Internet site.

18. A method according to claim 1 wherein the diagnostic information is obtained by an agent received from an Internet source.

19. A method according to claim 1 wherein the interested party is a computer support agent.

20. A method according to claim 19 wherein the agent is received using an object-oriented component such as an applet or ActiveX control.

21. A method according to claim 1 wherein a connection is established with an update database, such that updated or replacement software components may be downloaded to the computer.

22. A method according to claim 21 wherein the connection is established using the or an additional servlet.

23. An arrangement for providing remote support to a computer user, comprising:
a) a configuration information gathering element, operable to gather configuration information relating to the computer,
b) a configuration information dispatch element, operable to dispatch the configuration information to a holding location,
c) a location identifier receiving element, operable to receive a location identifier which identifies the holding location,
d) a location identifier transmission element, operable to transmit the location identifier to a remote support agent, and
e) a support agent connection element, operable to establish a connection to the holding location, whereby the support agent may access the configuration information.

24. In a support agent environment, apparatus for providing remote support to a computer user, comprising
a) a location identifier receiving element, operable to receive, from the computer, a location identifier which identifies a holding location at which is held configuration information relating to the computer, and
b) a support agent connection element, operable to establish a connection to the holding location, whereby the support agent may access the configuration information.

25. Apparatus according to claim 24 wherein the location identifier receiving element comprises a decoder, to decode the location identifier, which is such that it does not allow a human directly to understand the information provided thereby.

26. In a client environment, apparatus for obtaining remote support for a computer user, comprising:
a) a configuration information gathering element, operable to gather configuration information relating to the computer,
b) a configuration information dispatch element, operable to dispatch the configuration information to a holding location,
c) a location identifier receiving element, operable to receive a location identifier which identifies the holding location,
d) a location identifier transmission element, operable to transmit the location identifier to a remote support agent, whereby the support agent may access the configuration information to provide remote support to the user.

27. A method of providing access to computer diagnostic information to an remote support agent comprising:
a) obtaining the information using a software agent received from an internet source;
b) using a first data channel to pass the information to an internet site unknown to the computer support agent,
c) receiving, using the computer, information defining a URL, and
d) using a second data channel to transmit the information defining a URL to the computer support agent to enable the agent to access the information at the internet site in a form differing from that in which it is received by the computer, the transmission over the second data channel comprising a sound.

28. A method according to claim 27 wherein the transmission is such that it does not allow a human to understand the information directly from the transmission.

29. A method according to any one of claim 2 wherein the Internet site is created dynamically using the diagnostic information.

30. A method according to claim 29 wherein at least one internet site is generated and accessed automatically upon receipt by the support agent of the location identifier.

31. Apparatus for providing access to computer diagnostic information to an remote support agent comprising:
a) a software agent for obtaining the information;
b) means to pass the information to an internet site unknown to the computer support agent using a first data channel,
c) means for receiving information defining a URL, and
d) means to transmit, using a second data channel, the information defining a URL to the computer support agent in a form differing from that in which it is received by the computer to enable the agent to access the information at the internet site, the transmission over the second data channel comprising a sound.

32. Apparatus according to claim 31 wherein the transmission is such that it does not allow a human to understand the information directly from the transmission.

33. An arrangement for providing access to computer diagnostic information to an remote support agent comprising:
a) an execution environment for executing a software agent from an internet source;
b) computer program code for passing the diagnostic information to an internet site unknown to the computer support agent using a first data channel,
c) computer program code for receiving information defining a URL, and
d) computer program code for transmitting, using a second data channel, the information defining a URL to the computer support agent in a form differing from that in which it is received by the computer to enable the agent to access the information at the internet site, the transmission over the second data channel comprising a sound.

34. An arrangement according to claim 33 comprising an encoder for encoding the transmission such that it does not allow a human to understand the information directly from the transmission.
